(19) United States
(12) Patent Application Publication
(10) Pub. No.: US 2003/0123800 A1
(43) Pub. Date: Jul. 3, 2003

(54) Variable dispersion compensator and substrate for the same

(76) Inventors: Minoru Hashimoto, Tokyo (JP); Kiichi Yoshiara, Tokyo (JP); Takuya Ohhira, Tokyo (JP); Sadayuki Matsumoto, Tokyo (JP); Eiichi Sakurai, Tokyo (JP); Takashi Hashimoto, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/171,749

(22) Filed: Jun. 17, 2002

(30) Foreign Application Priority Data
Dec. 27, 2001 (JP) 2001-396255

(51) Int. Cl. G02B 6/26; G02B 6/34

(52) U.S. Cl. 385/40; 385/27; 385/37

(57) ABSTRACT

An optical dispersion compensator comprises a heater unit for heating a fiber grating, a heater controller and a Peltier controller. The fiber grating heater unit includes heater elements formed in line on a quartz substrate and a fiber grating arranged on the heater elements. The fiber grating is secured on the quartz substrate using a cap. A step is formed in the quartz substrate to position the cap relative to the heater elements. The fiber grating is inserted into a groove in the cap to position the fiber grating relative to the heater elements.

### FIELD OF THE INVENTION

The present invention relates to an apparatus for compensating dispersion in an optical signal by imparting a temperature distribution on a chirp grating.

### BACKGROUND OF THE INVENTION

An optical fiber communication system can transmit a large amount of information at a high speed. The optical fiber communication system comprises an optical signal source, an optical fiber transmission line for transmitting optical signals and an optical receiver for detecting and demodulating the optical signals. When an optical signal with a certain wavelength range is employed, a longer wavelength component has a lower propagation velocity than that of a shorter wavelength component and causes a delay. This delay time deteriorates a signal waveform. If a large number of channels are employed over a wide wavelength range, it is required to accurately compensate a difference (dispersion) between such the propagation velocities.

The dispersion compensation can be achieved through the use of a chirp grating. The chirp grating is located at the mid-portion in an optical fiber transmission path to reflect optical signals such that a shorter wavelength light passes through a longer path than a path through which a longer wavelength light passes. Negative wavelength dispersion is given to the optical signal when the shorter wavelength light passes through a longer path than the path through which the longer wavelength light passes. The negative wavelength dispersion is effective to compensate the dispersion occurred in the optical signal. When λB is used to denote a wavelength reflected at a grating (Bragg wavelength), Neff an effective index of the grating, and Λ a pitch in the grating, λB can be given from the following equation.

λB=219 Neff·Λ (1)

A linear variation in the grating pitch A can change the Bragg wavelength λB linearly. A linear reduction of the grating pitch Λ gradually from the incident side of the optical signal can achieve linear negative dispersion.

Various external factors affect on the optical fiber that is employed to configure the transmission path. Major external factors include temperatures and stresses. When a local variation in temperature or stress arises in the optical fiber, it varies the refractive index of the optical fiber. Variation in the refractive indexes of the optical fiber yields new dispersion in the optical signal, which cannot be compensated by a stationary grating.

The publication of Japanese Patent Application Laid-Open No. 2000-235170 discloses a variable dispersion compensator. The variable dispersion compensator disclosed in this publication comprises a plurality of micro-heaters provided on a fiber grating. Powers supplied to the micro-heaters are each adjusted to form an arbitrary temperature distribution over the length of the fiber grating. This temperature distribution varies the refractive index Neff of the grating to finely adjust the Bragg wavelength λB, compensating the dispersion in the optical signal.

The plural micro-heaters are formed in line on a substrate and the fiber grating is mounted on the micro-heaters. If the fiber grating cannot be mounted accurately on the micro-heaters, the temperature distribution in the fiber grating cannot be set to a desirable value even though the powers supplied to the micro-heaters are adjusted individually. Because a displacement between the micro-heaters and the fiber grating causes an error in a correlation between the powers consumed in the micro-heaters and the temperatures in the fiber grating.

A solution to this problem lies in an increase in a heater area that is effective to compensate the displacement between the heaters and the fiber grating. The increased heater area, however, invites an increase in the power consumption. Accordingly, it is required to correctly define a positional relation of the heater relative to the fiber grating in order to compensate the wavelength dispersion in the optical signal.

### SUMMARY OF THE INVENTION

It is an object of this invention to provide an apparatus capable of correctly and easily positioning a fiber grating or chirp grating relative to a heater.

The variable dispersion compensator according to one aspect of this invention comprises a substrate, a fiber grating arranged on the substrate, a plurality of heater elements arranged along the axis of the fiber grating and in contact with the fiber grating, and a cap located on the substrate for securing the fiber grating. The substrate is provided with a step formed along the axis for positioning the cap relative to the heater elements.

The variable dispersion compensator according to another aspect of this invention comprises a substrate, a chirp grating arranged on the substrate, and a heating unit arranged along the axis of the chirp grating for varying a temperature distribution in the chirp grating. The variable dispersion compensator also comprises a cap located on the substrate for securing the chirp grating, and a positioning unit provided along the axis for positioning the cap relative to the heating unit.

The substrate for a variable dispersion compensator according to still another aspect of this invention, comprises a plurality of heater elements arranged in line, and a step formed in parallel with the heater elements.

The substrate for a variable dispersion compensator according to still another aspect of this invention, comprises a positioning groove formed in line, and a groove for locating a fiber grating, the groove for locating a fiber grating formed within the positioning groove and in parallel with the positioning groove.

The substrate for a variable dispersion compensator according to still another aspect of this invention, comprises a plurality of heater elements arranged in line, a first step formed in parallel with the heater elements, and a second step formed in normal to the heater elements.

Other objects and features of this invention will become apparent from the following description with reference to the accompanying drawings.

### BRIEF DESCRIPTION OF THE DRAWINGS

FIG. 1 is a diagram showing a configuration of an optical fiber communication system,

FIG. 2 is a block diagram showing a configuration of an optical dispersion compensator in FIG. 1,

FIG. 3 is a perspective view of a fiber grating heater unit in FIG. 2,

FIG. 4 shows a relation between a fiber grating and heater elements in the fiber grating heater unit,

FIG. 5 shows a relation between a heater position and a temperature distribution in the fiber grating,

FIG. 6 shows a relation between a wavelength of an optical signal and a group delay time,

FIG. 7 shows how the fiber grating heater unit is produced,

FIG. 8 shows how the fiber grating heater unit is produced,

FIG. 9 shows how the fiber grating heater unit is produced,

FIG. 10 is a plan view of the fiber grating heater unit,

FIG. 11 is a perspective view of part of the fiber grating heater unit shown in FIG. 10,

FIG. 12 is a side view of the fiber grating heater unit shown in FIG. 10,

FIG. 13 is a plan view of another fiber grating heater unit,

FIG. 14 is a plan view of a further fiber grating heater unit,

FIG. 15 is a plan view of a still further fiber grating heater unit,

FIG. 16 is a plan view of a still further fiber grating heater unit,

FIG. 17 is a side view of the fiber grating heater unit shown in FIG. 16,

FIG. 18 is a plan view of a still further fiber grating heater unit,

FIG. 19 is a side view of the fiber grating heater unit shown in FIG. 18,

FIG. 20 is a plan view of a still further fiber grating heater unit,

FIG. 21 is a side view of the fiber grating heater unit shown in FIG. 20, and

FIG. 22 is a plan view of a still further fiber grating heater unit.

### DETAILED DESCRIPTION

Embodiments of the present invention will be described below with reference to the accompanying drawings.

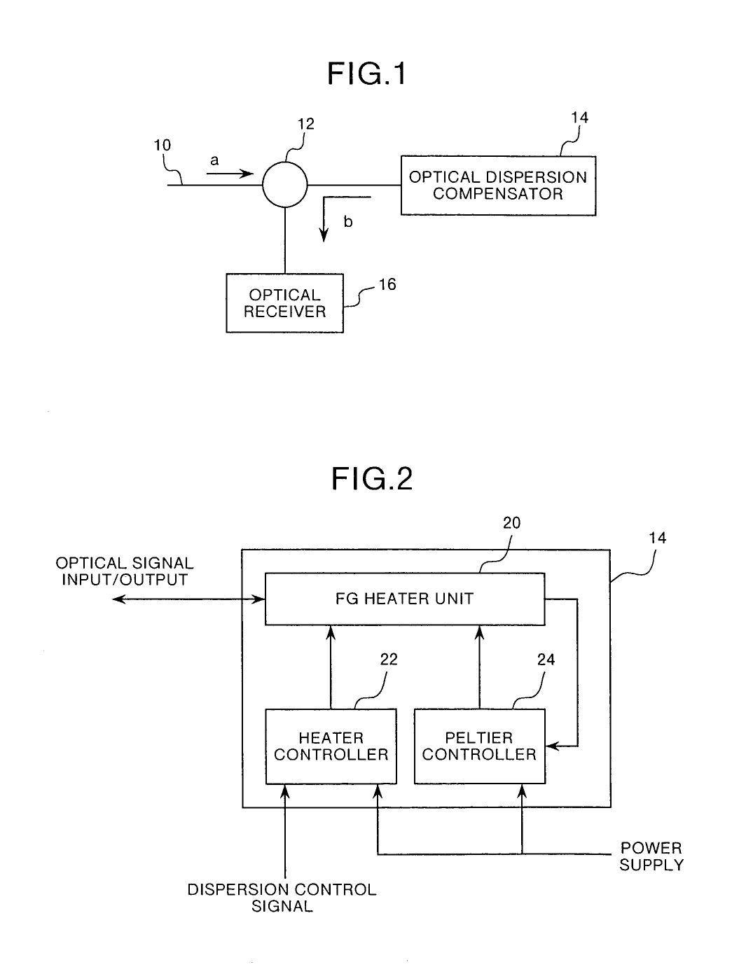

FIG. 1 shows an optical fiber communication system according to an embodiment. An optical signal from a source, not depicted, is transmitted through an optical fiber transmission path 10 to a circulator 12. The circulator 12 is coupled to an optical dispersion compensator 14 through the optical fiber transmission path 10. The optical signal separated at the circulator 12 is supplied to the optical dispersion compensator 14 through the optical fiber 10 as indicated by the path-a. The optical dispersion compensator 14 is employed to compensate dispersion in the input optical signal. The optical signal, dispersion-compensated and reflected at the optical dispersion compensator 14, reenters the circulator 12. The optical signal, dispersion-compensated and entering the circulator 12, is supplied to an optical receiver 16 as indicated by the path-b. The optical receiver 16 is employed to detect and demodulate the input optical signal. The optical dispersion compensator 14 is a variable dispersion compensator, which comprises a fiber grating and a heater. The heater produces heat for giving a desired temperature distribution in the fiber grating to impart a desired variation in the effect index Neff of the fiber grating. Other than the variable dispersion compensator 14, a stationary dispersion compensator may also be provided in the optical fiber transmission path. In this case, the stationary dispersion compensator is employed to roughly compensate the dispersion in the optical signal, which is then finely compensated in the variable dispersion compensator 14.

FIG. 2 is a block diagram showing the configuration of the optical dispersion compensator 14 in FIG. 1. The optical dispersion compensator 14 comprises a fiber grating (FG) heater unit 20, a heater controller 22 and a Peltier controller 24. The optical signal from the circulator 12 enters the FG heater unit 20. The optical signal is Bragg-reflected at the FG heater unit 20 and reenters the circulator 12. The FG heater unit 20 includes a plurality of heater elements arranged in line. An amount of heat from each heater element is controlled at the heater controller 22. The heater controller 22 is employed to adjust a power supplied to each heater element based on a dispersion control signal from a controller, not depicted. More specifically, the heater controller 22 adjusts an amount of a current supplied to each heater element. The FG heater unit 20 is provided with a Peltier unit in addition to the heater elements. An amount of heat from the Peltier unit is controlled at the Peltier controller 24. The Peltier controller 24 feedback-controls the Peltier unit based on a signal indicating substrate temperature from the FG heater unit 20 to keep a uniform and constant substrate temperature. Drive powers for the heater controller 22 and the Peltier controller 24 are supplied from external.

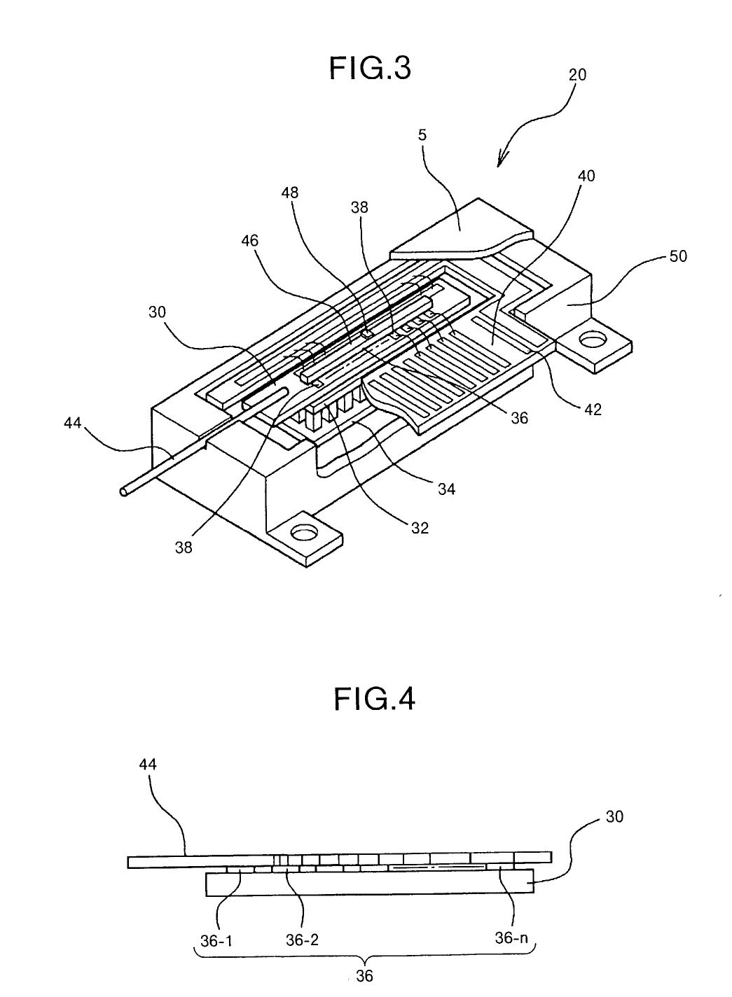

FIG. 3 shows the FG heater unit 20 in a perspective view. Plural heater elements 36 are formed on the surface of a quartz substrate 30 in line along the axis of a fiber grating 44. The quartz substrate 30 has a low thermal conductivity effective to suppress thermal diffusion from the heater elements 36. In this embodiment the substrate 30 employs a quartz material as a non-limited example and may also be composed of a different material. Preferably, such the different material has a low thermal conductivity, for example, of 0.005 W/mm° C. or less. The heater elements 36 are split into 34 pieces in this embodiment. The heater elements 36 are required to have such conditions that include a small area of each element, a large number of the elements and a small element interval. The element interval is important to achieve a linear temperature distribution in the fiber grating 44. Each of the heater elements 36 is connected to each of electrodes 38. The electrodes 38 are arranged in two electrode arrays that sandwich the heater elements 36 therebetween. The electrodes 38 are bonded via wires to terminals 42 formed on a relay substrate 40. The fiber grating 44 is fixed at a certain location on the substrate 30 with a cap 46 for securing the fiber grating. On the upper surface of the cap 46 for securing the fiber grating, a thermistor 48 is formed. The thermistor 48 is employed to detect a temperature of the cap 46 or a temperature of the quartz substrate 30, which is supplied to the Peltier controller 24. A Peltier unit 34 is provided beneath the quartz substrate 30 interposing a heat spreader 32 therebetween. The Peltier unit 34 radiates or absorbs heat when a current flows through it. Therefore, it is employed to set uniform and constant temperatures of the quartz substrate 30. The quartz substrate 30, the heat spreader 32 and the cap 46 for securing the fiber are housed in a case 50. The case 50 has a cover 5 for tightly sealing inside. The fiber grating 44 extends outwardly through a groove formed in the case 50. The fiber grating 44 is coupled to the optical fiber transmission path 10, which is in turn coupled to the circulator 12.

FIG. 4 shows the quartz substrate 30, the heater elements 36 and the fiber grating 44, which are contained in the FG heater unit 20. The heater element 36 consists of 34 elements, which are referred to as heater elements 36-1, 36-2, . . . , 36-n (n=34). The heater controller 22 is employed to adjust an amount of a current fed to each of the heater elements 36-1, 36-2, . . . , 36-n to control the temperature distribution in the fiber grating 44. The plural heater elements 36-1, 36-2, . . . , 36-n are formed on the quartz substrate 30 in such a manner that they can cover the grating region of the fiber grating 44.

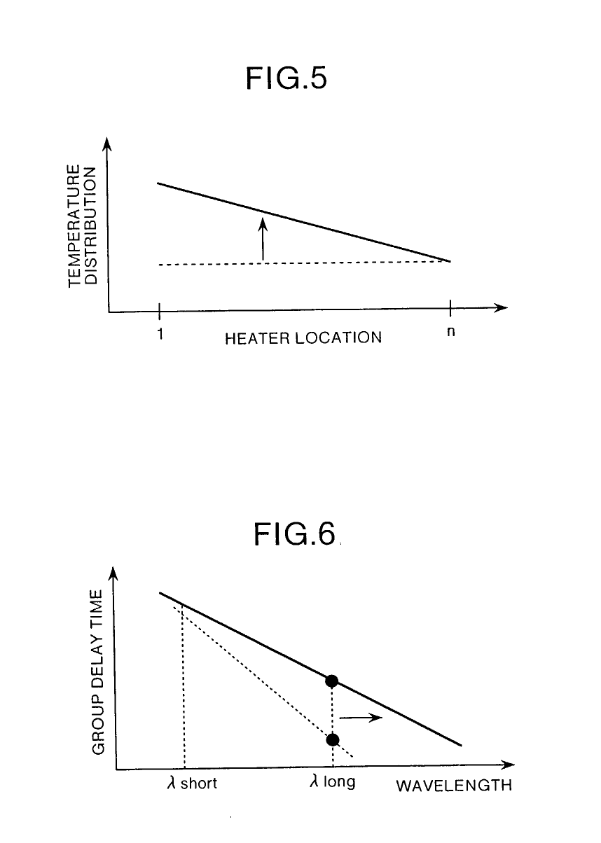

FIG. 5 shows an example of the temperature distribution in the fiber grating 44. Adjustment of the amounts of currents fed to the heater elements 36-1 through 36-n is possible to form a linear temperature distribution that exhibits the highest temperature at the location 36-1 and the lowest temperature at the location 36-n. In FIG. 5 a dashed line depicts a temperature distribution in the fiber grating 44 when the heater elements 36 are not energized and a solid line depicts a temperature distribution in the fiber grating 44 when the heater elements 36 are energized.

FIG. 6 shows a group delay time related to a wavelength of the optical signal when the linear temperature distribution shown in FIG. 5 is imparted on the fiber grating 44. If the fiber grating 44 has a higher temperature in a part, the part has an increased refractive index and an increased Bragg reflection wavelength λB. The increased Bragg reflection wavelength λB invites a lengthened path and an increased group delay time into the part. A longer part in the grating pitch Λ can be assumed at the higher temperature side and a shorter part in the grating pitch Λ at the lower temperature side. In this case, a shorter wavelength component λshort has a group delay time substantially unchanged and a longer wavelength component λlong has a group delay time increased.

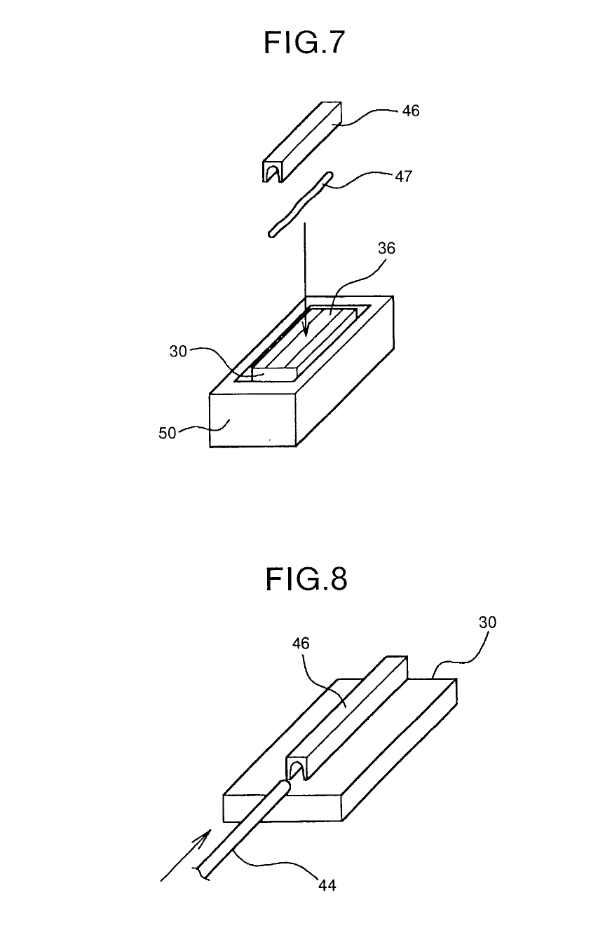

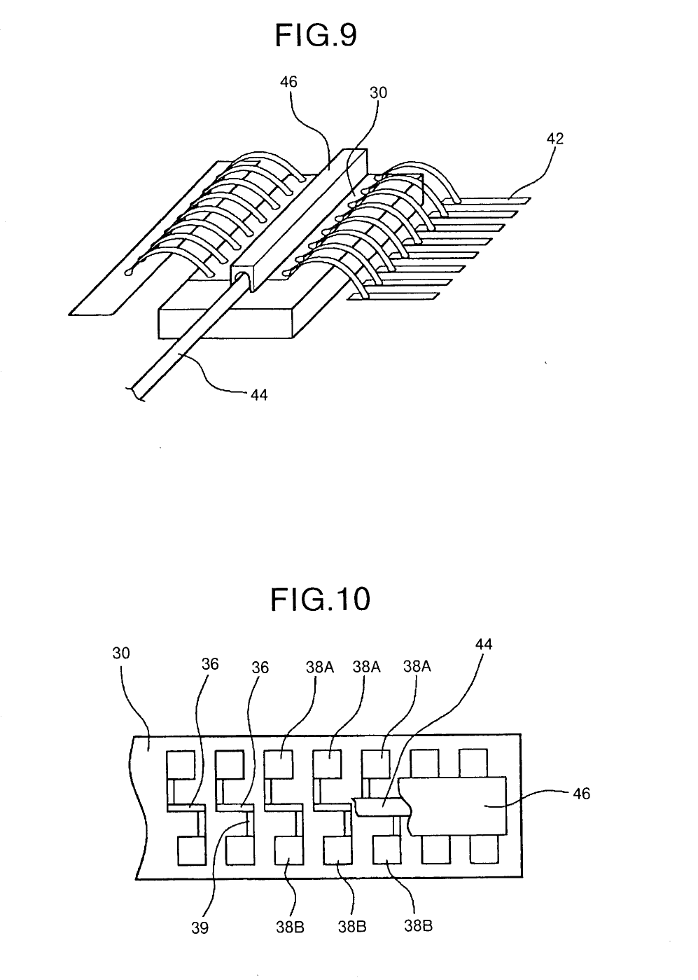

FIG. 7 to FIG. 9 show a method of producing the FG heater unit 20. The heater elements 36 are patterned first on the surface of the quartz substrate 30. The electrodes 38 are also patterned simultaneously with the heater elements 36. The cap 46 is then positioned relative to the heater elements 36 to secure the cap 46 on the quartz substrate 30. The cap 46 has a straight groove formed therein for receiving the fiber grating 44 inserted therein. A silicone gel 47 is filled within the groove in the cap 46. The silicone gel 47 can be obtained in the process of modifying a liquid silicone to a solid form by halting the reaction. The silicone gel 47 is filled in a gap formed between the fiber grating 44 and the groove in the cap 46. The silicone gel 47 has a low hardness effective to decrease a stress applied to the fiber grating 44. The silicone gel 47 serves as a heat insulating material once air is removed from the gap. After the cap 46 is secured on the substrate 30, the fiber grating 44 is inserted into the groove of the cap 46 as shown in FIG. 8. After the fiber grating 44 is inserted into the groove of the cap 46, the electrodes 38 respectively connected to the heater elements 36 are bonded via wires to the terminals 42 as shown in FIG. 9. If the cap 46 is correctly positioned relative to the heater elements 36, the fiber grating 44 can be correctly positioned on the heater elements 36. In contrast, if the cap 46 is not correctly positioned relative to the heater elements 36, the groove of the cap 46 forms a certain angle with the heater elements 36 and accordingly the fiber grating 44 cannot be correctly positioned on the heater elements 36. If the cap 46 displaces from the heater elements 36, a desired temperature distribution cannot be formed in the fiber grating 44 even though the heater elements 36 are energized to heat the fiber grating 44. In this embodiment, a step is formed in the substrate 30 to correctly position and secure the cap 46 on the substrate 30. The cap 46 is located and secured along the step formed in the substrate 30.

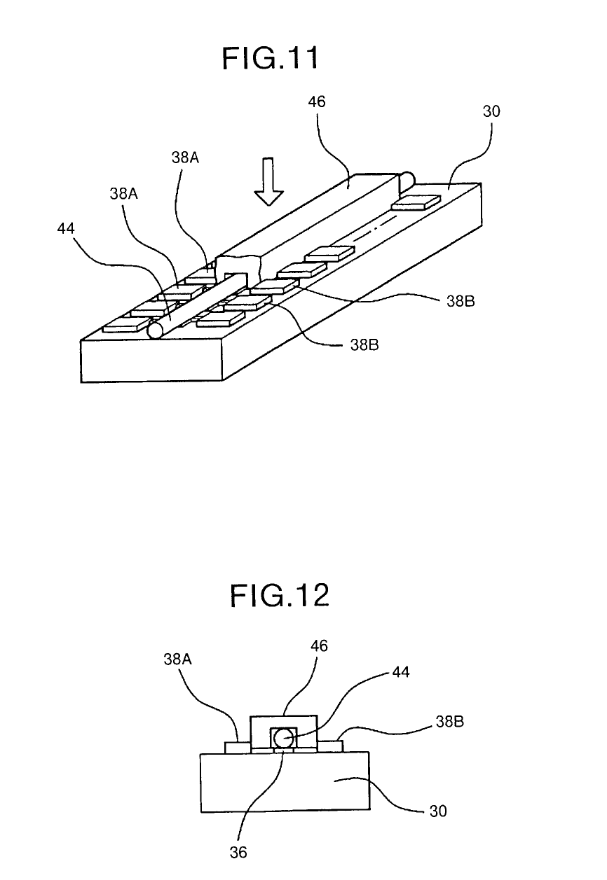

FIG. 10 shows an FG heater unit 20 in a plan view. For convenience of description, the cap 46 and the fiber grating 44 depicted are partly cutaway. Electrodes 38A and 38B are arranged in plural to sandwich the plural heater elements 36 between them. The electrodes 38A, 38B are formed in parallel with the heater elements 36. Each of the heater elements 36 is connected via a wired pattern 39 to the electrodes 38A, 38B. When a voltage is applied across the electrodes 38A and 38B, a current flows into the corresponding heater element 36, which in turn produces heat. The electrodes 38A, 38B are formed thicker than the heater element 36 and the wired pattern 39. The heater element 36 has a thickness of 0.5 μm or less, the wired pattern 39 about 3 μm, and the electrodes 38A, 38B about 10 μm. Thicker electrodes 38A, 38B can form a step on the substrate 30. The step has a thickness of about 7 μm. As shown in FIG. 11, if the cap 46 is secured on the substrate 30, the cap 46 can be secured along the step formed on the substrate 30 by the thickness of the electrodes 38A, 38B. The step is formed in parallel with the heater elements 36. Therefore, the cap 46 can be correctly positioned relative to the heater elements 36. After the cap 46 is positioned on the substrate 30, the fiber grating 44 can be inserted into the groove in the cap 46. In this case, as shown in FIG. 12, the fiber grating 44 can be positioned correctly on the heater elements 36. Accordingly, when the heater elements 36 are energized, a desired temperature distribution, for example, a linear temperature distribution can be given to the fiber grating 44.

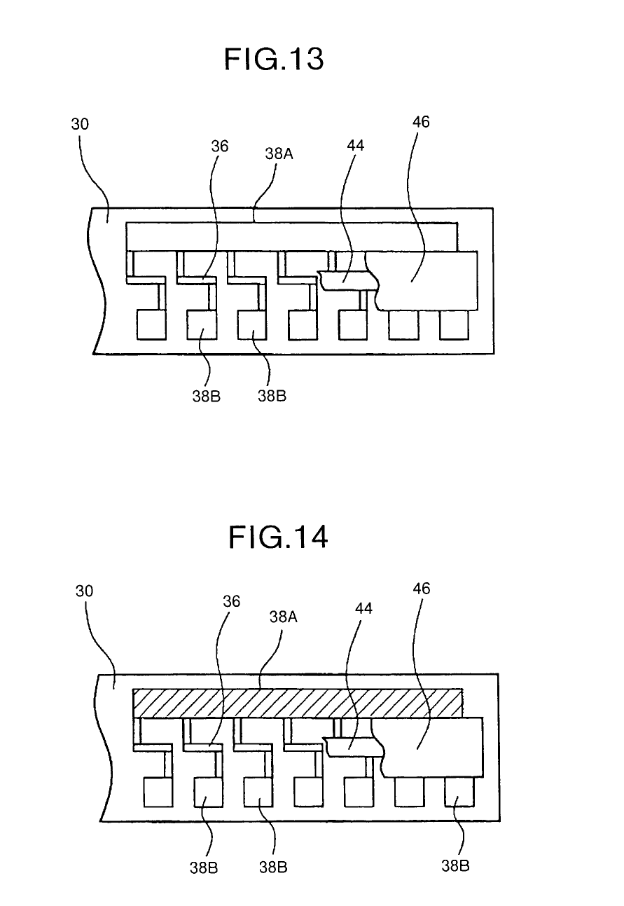

FIG. 13 shows another FG heater unit 20 in a plan view. In the FG heater unit 20 shown in FIG. 10, the electrodes 38A and 38B are both provided per heater element 36. In contrast, in FIG. 13 only one electrode 38A is provided commonly to a plurality of heater elements 36. In this case, the electrodes 38 include a common electrode 38A and individual electrodes 38B. The common electrode 38A and the individual electrodes 38B are both formed thicker than the heater elements 36 and the wired patterns 39. The thickness of the electrodes 38A and 38B forms a step. When the cap 46 is interposed between the electrodes 38A and 38B, the cap 46 can be correctly positioned relative to the heater elements 36.

The electrodes 38A and 38B shown in FIG. 10 and FIG. 13 are both formed thicker than the heater elements 36 and the wired patterns 39. It is not required, however, to form all of the electrodes 38 thicker. To position the cap 46, it is sufficient to thicken either of the electrodes 38 formed in parallel with the heater elements 36. For example, only the common electrode 38A may be formed thicker. In this case, the individual electrodes 38B may be formed to have a thickness almost similar to that of the wired patterns 39. Alternatively, electrodes only at both sides in the individual electrodes 38B may be formed thicker.

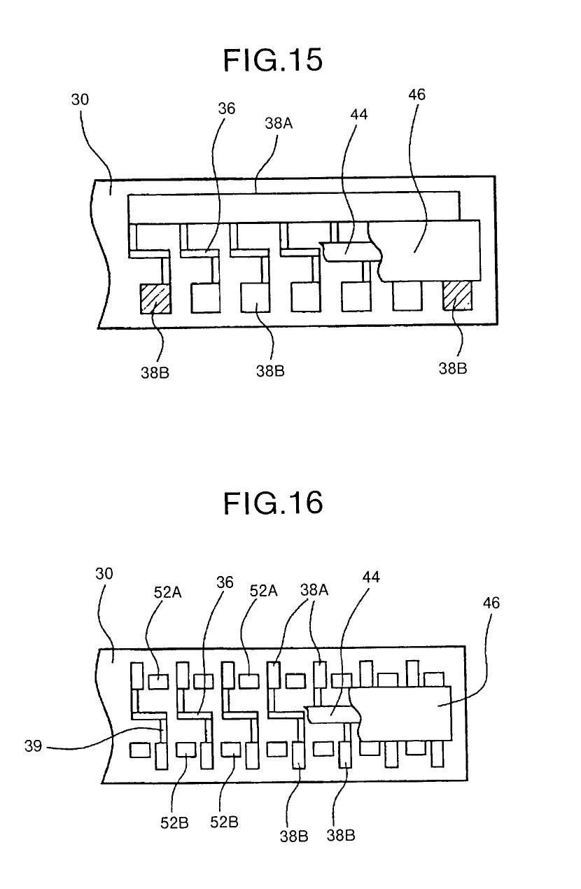

FIG. 14 is a plan view which shows the common electrode 38A that is only one thickened. FIG. 15 is a plan view which shows the electrodes that are thickened only at both sides in the individual electrodes 38B. In both figures, hatched parts indicate the thickened electrodes.

In the FG heater units 20 shown in FIG. 10 to FIG. 15, preferably the step formed by the thickness of the electrodes 38 is not less than 1 μm, more preferably 5 μm. For example, the step is designed more than 5 μm and less than 100 μm. A step less than 1 μm allows the cap 46 to easily get over the step and makes it difficult to position the cap. A deeper step formed from the excessively thickened electrodes 38 makes the electrodes 38 difficult to be formed and easily peelable when a thermal stress acts, for example.

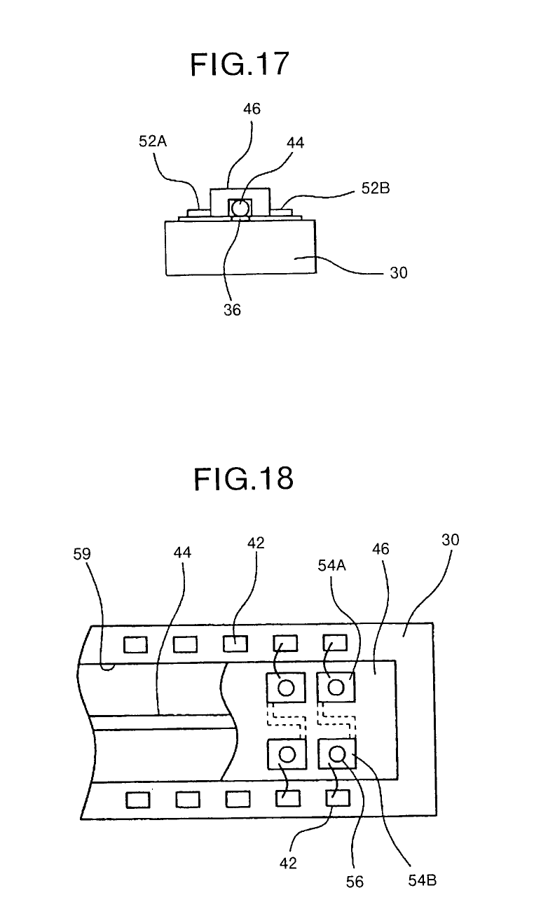

FIG. 16 shows a further FG heater unit 20 in a plan view. The heater elements 36, the wired patterns 39 and the electrodes 38A, 38B are formed on the substrate 30. Plural guide members 52A, 52B are formed on the substrate 30 in parallel with the heater elements 36. The guide members 52A are formed between the electrodes 38A. The guide members 52B are formed between the electrodes 38B. The electrodes 38A, 38B have a thickness similar to that of the wired patterns 39. The guide members 52A, 52B have a thickness larger than any one of the heater elements 36, the wired patterns 39 and the electrodes 38A, 38B. The heater elements 36 have a thickness of 0.5 μm or less. The wired patterns 39 and the electrodes 38A, 38B have a thickness of about 3 μm. The guide members 52 have a thickness that can satisfy the above condition and is, for example, equal to about 20 μm. The thickness of the guide members 52A, 52B forms a step similar to the electrodes 38A, 38B in FIG. 10. If the cap 46 is secured on the substrate 30, located along the guide members 52A, 52B, the cap 46 can be correctly positioned relative to the heater elements 36. Accordingly, as shown in FIG. 17, when the fiber grating 44 is inserted into the groove in the cap 46, the cap 46 can be correctly positioned relative to the heater elements 36.

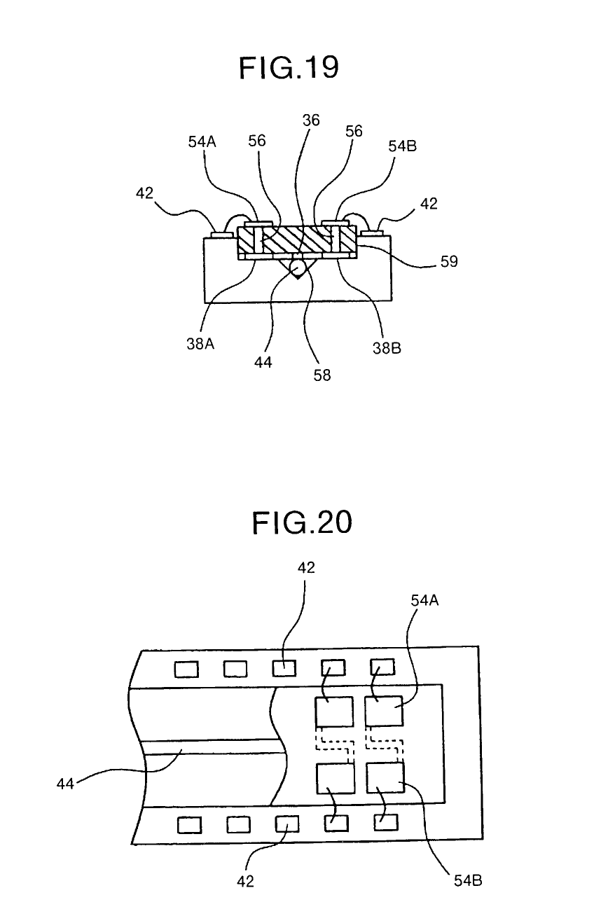

FIG. 18 shows a still further FG heater unit 20 in a plan view. FIG. 19 is a side view which shows the FG heater unit 20 shown in FIG. 18. The heater elements 36 are formed along the axis of the fiber grating 44 in line not on the substrate 30 but on the lower surface of the cap 46 for securing the fiber grating 44. The electrodes 38A, 38B and the wired patterns for connecting the electrodes 38A, 38B to the heater elements 36 are formed on the lower surface of the cap 46. The electrodes 38A, 38B are connected respectively to electrodes 54A, 54B formed on the upper surface of the cap 46 via through-holes 56 that extend from the lower surface to the upper surface of the cap 46. The electrodes 54A, 54B are bonded via wires to the terminals 42, respectively. The substrate 30 is provided with a V-shaped or U-shaped groove 58 formed therein. The fiber grating 44 is disposed in the groove 58. The substrate 30 is also provided with a groove 59 formed therein that is employed for positioning the cap 46. The positioning groove 59 is wider than the groove 58 for receiving the fiber grating 44 inserted. The positioning groove 59 is formed in parallel with the groove 58. The positioning groove 59 has a depth in a suitable dimension for positioning the cap 46, for example, of 0.3 mm. The depth of the V- or U-shaped groove 58 is almost similar to the diameter of the fiber grating 44, for example, 125 μm. After the fiber grating 44 is positioned in the groove 58, the cap 46 is arranged and secured along the positioning groove 59. The heater elements 36, which has been already formed on the lower surface of the cap 46, touch the fiber grating 44 when the cap 46 is disposed in the groove 59. The cap 46 can be accurately positioned by the positioning groove 59. Thus, the heater elements 36 can be positioned correctly along the axis of the fiber grating 44.

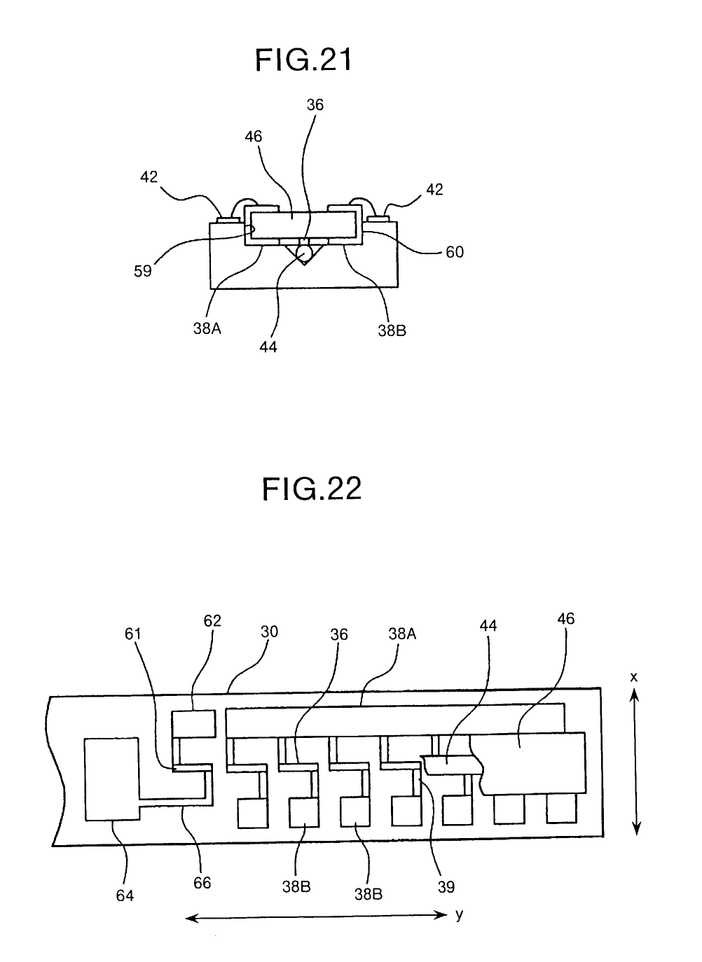

The electrodes 38A, 38B formed on the lower surface of the cap 46 and the electrodes 54A, 54B formed on the upper surface of the cap 46 are connected via the through-holes 56. Alternatively, other methods may be employed to establish electric contacts between the electrodes 38A, 38B and the upper surface of the cap. FIG. 20 and FIG. 21 show another method of connecting the electrodes 38A, 38B to the electrodes 54A, 54B. The electrodes 38A, 38B are connected to the electrodes 54A, 54B via wired patterns 58 that make detours around the side of the cap 46.

FIG. 22 shows a still further FG heater unit 20 in a plan view. An additional heater element 61 is formed on the substrate 30 outside the heater elements 36. The heater element 61 has a function to further adjust the temperature distribution, formed by the heat from the heater elements 36, in the fiber grating 44. The heater element 61 is connected to electrodes 62 and 64 via wired patterns 66. Application of a voltage across the electrodes 62 and 64 generates a current flowing into the heater element 61. The electrode 64 is located on the axis of the fiber grating 44 and formed as thick as 10 μm similar to the common electrode 38A and the individual electrode 38B. The thickened electrode 64 is effective to form a step on the substrate 30 in the direction normal to the axis. The electrodes 62 and 64 can be patterned in the same process as that for the common electrode 38A and individual electrodes 38B. When the cap 46 is secured on the substrate 30, an end of the cap 46 touches the electrode 64 to position the cap 46. The step formed by the common electrode 38A and individual electrodes 38B restricts a cap position in the x-direction normal to the axis of the fiber grating 44. The step formed by the electrode 64 restricts a cap position in the y-direction along the axis of the fiber grating 44.

According to the present invention, the cap can be arranged on the substrate using the step formed in the substrate as a guide for correctly positioning the cap relative to the heater elements. Positioning of the cap relative to the heater elements allows the fiber grating secured by the cap to be correctly positioned relative to the heater elements.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A variable dispersion compensator comprising:
a substrate;
a fiber grating arranged on the substrate;
a plurality of heater elements arranged along the axis of the fiber grating and in contact with the fiber grating; and
a cap located on the substrate for securing the fiber grating, wherein the substrate is provided with a step formed along the axis for positioning the cap relative to the heater elements.

2. The variable dispersion compensator according to claim 1, wherein the substrate is provided with a plurality of electrodes formed thereon, the electrodes connected to the heater elements via wired patterns, and
the electrodes formed along the axis have a thickness thicker than those of the heater elements and the wired patterns, the thickness of the electrodes forming the step.

3. The variable dispersion compensator according to claim 2, wherein the electrodes include a first electrode element and a second electrode element arranged to sandwich the heater elements therebetween,
the first electrode element is provided individually to each of the heater elements,
the second electrode element is provided commonly to the heater elements, and
at least one of the first and second electrode elements has a thickness thicker than those of the heater elements and the wired patterns.

4. The variable dispersion compensator according to claim 2, wherein the electrodes have a thickness thicker than that of the heater elements by 1 μm or more.

5. The variable dispersion compensator according to claim 2, wherein the electrodes have a thickness thicker than that of the heater elements by 5 μm or more.

6. The variable dispersion compensator according to claim 1, wherein the substrate is provided along the axis with a guide having a thickness thicker than that of the heater elements, the thickness of the guide forming the step.

7. The variable dispersion compensator according to claim 6, wherein the guide has a thickness thicker than that of the heater elements by 1 μm or more.

8. The variable dispersion compensator according to claim 6, wherein the guide has a thickness thicker than that of the heater elements by 5 μm or more.

9. The variable dispersion compensator according to claim 1, wherein the substrate is provided along the axis with a first groove and a second groove wider than the first groove, the fiber grating arranged in the first groove, and the second groove forming the step.

10. The variable dispersion compensator according to claim 9, wherein the heater elements are formed along the axis on the lower surface of the cap.

11. The variable dispersion compensator according to claim 10, wherein the cap is provided with through-holes formed therein, the through-holes extending from the lower surface to the upper surface for supplying power to the heater elements.

12. The variable dispersion compensator according to claim 9, wherein the second groove has a depth of at least 1 μm or more.

13. The variable dispersion compensator according to claim 9, wherein the second groove has a depth of at least 5 μm or more.

14. The variable dispersion compensator according to claim 1, further comprising a temperature control unit which controls the power supplied to the heater elements to vary a temperature distribution in the fiber grating.

15. The variable dispersion compensator according to claim 1, further comprising a Peltier unit located on the lower surface of the substrate for evening temperatures of the substrate.

16. A variable dispersion compensator comprising:
a substrate;
a chirp grating arranged on the substrate;
a heating unit arranged along the axis of the chirp grating for varying a temperature distribution in the chirp grating;
a cap located on the substrate for securing the chirp grating; and
a positioning unit provided along the axis for positioning the cap relative to the heating unit.

17. The variable dispersion compensator according to claim 16, wherein the positioning unit consists of a plurality of electrodes provided on the substrate along the axis for supplying power to the heating unit.

18. The variable dispersion compensator according to claim 16, wherein the positioning unit consists of a protrusion provided on the substrate along the axis.

19. The variable dispersion compensator according to claim 16, wherein the positioning unit consists of a groove formed in the substrate along the axis.

20. The variable dispersion compensator according to claim 16, further comprising a temperature control unit which controls a heating value of the heating unit.

21. The variable dispersion compensator according to claim 16, further comprising a substrate temperature control unit which evens temperatures of the substrate.

22. A substrate for a variable dispersion compensator, the substrate comprising:
a plurality of heater elements arranged in line; and
a step formed in parallel with the heater elements.

23. The substrate for a variable dispersion compensator according to claim 22, the substrate further comprising a plurality of electrodes connected to the heater elements via wired patterns, the electrodes arranged in parallel with the heater elements and having a thickness to form the step.

24. The substrate for a variable dispersion compensator according to claim 23, wherein the electrodes include a first electrode element and a second electrode element arranged to sandwich the heater elements therebetween,
the first electrode element is provided individually to each of the heater elements,
the second electrode element is provided commonly to the heater elements, and
at least one of the first and second electrode elements forms the step.

25. The substrate for a variable dispersion compensator according to claim 22, wherein the step has a thickness of 1 μm or more.

26. The substrate for a variable dispersion compensator according to claim 22, wherein the step has a thickness of 5 μm or more.

27. The substrate for a variable dispersion compensator according to claim 22, the substrate further comprising a guide arranged in parallel with the heater elements, the guide having a thickness to form the step.

28. A substrate for a variable dispersion compensator, the substrate comprising:
a positioning groove formed in line; and
a groove for locating a fiber grating, formed within the positioning groove and in parallel with the positioning groove.

29. The substrate for a variable dispersion compensator according to claim 28, where the positioning groove has a depth of 1 μm or more.

30. The substrate for a variable dispersion compensator according to claim 28, wherein the positioning groove has a depth of 5 μm or more.

31. The variable dispersion compensator according to claim 1, further comprising another step formed in the substrate in the direction normal to the axis for restricting a position of the cap on the axis.

32. The variable dispersion compensator according to claim 31, further comprising:
a sub-heater element provided in the vicinity of the heater elements; and
a sub-electrode connected to the sub-heater element, the sub-electrode formed on the axis and thicker than the heater elements, and the sub-electrode having a thicker thickness to form the another step.

33. A substrate for a variable dispersion compensator, the substrate comprising:
a plurality of heater elements arranged in line;
a first step formed in parallel with the heater elements; and
a second step formed in normal to the heater elements.

34. The substrate for a variable dispersion compensator according to claim 33, the substrate further comprising:
a plurality of electrodes connected to the heater elements via wired patterns;
a sub-heater element provided in the vicinity of the heater elements; and
a sub-electrode connected to the sub-heater element via a wired pattern, the electrodes having a thickness to form the first step, and the sub-electrode having a thickness to form the second step.
